(19) United States
(12) Patent Application Publication
(10) Pub. No.: US 2019/0126934 A1
(43) Pub. Date: May 2, 2019

(54) METHODS AND SYSTEMS FOIR REMOTELY CONTROLLING COMFORT SETTTING(S) WITHIN A VEHICLE

(71) Applicant: GM GLOBAL TECHNOLOGY OPERATIONS LLC, Detroit, MI (US)

(72) Inventors: Carl W. Wellborn, Detroit, MI (US); Michael D. Munger, Grand Blanc, MI (US); Joseph Neighbors, Milford, MI (US); Raymond A. Beaufait, Macomb, MI (US)

(73) Assignee: GM GLOBAL TECHNOLOGY OPERATIONS LLC, Detroit, MI (US)

(21) Appl. No.: 15/802,125

(22) Filed: Nov. 2, 2017

(51) Int. Cl. B60W 50/00; G08C 17/02; G06Q 10/02; B60H 1/00

(52) U.S. Cl. CPC B60W 50/0098; H04W 4/046; G05D 1/0088; G06Q 10/02; B60H 1/00657; G08C 17/02

(57) ABSTRACT

Systems and method are provided for remotely controlling one or more comfort settings within a cabin of a vehicle. The vehicle includes one or more comfort sub-systems, a communication interface, and a controller. The communication interface receives control signals from a comfort settings management system. The control signals indicate one or more comfort settings of the one or more comfort sub-systems. The controller can generate commands, based on the control signals, that automatically adjust settings of the one or more comfort sub-systems to control the one or more comfort settings within the vehicle.

### INTRODUCTION

The present disclosure generally relates to vehicles, and more particularly relates to systems and methods for remotely controlling comfort settings within a cabin of a vehicle.

Each passenger within a vehicle can have different preferences regarding settings of vehicle sub-systems that affect that passenger's comfort level. Different passengers have different preferences regarding, for example, temperature, lighting, and soundscape within the cabin of the vehicle.

Autonomous vehicles are being designed and developed along with autonomous vehicle based remote transportation systems. An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from zero, corresponding to no automation with full human control, to five, corresponding to full automation with no human control. Various automated driver-assistance systems, such as cruise control, adaptive cruise control, and parking assistance systems correspond to lower automation levels, while true “driverless” vehicles correspond to higher automation levels. Autonomous vehicle based remote transportation systems are being planned that will allow passengers to schedule rides using an application that executes on a smartphone or other device.

Because each passenger has their own unique set of preferences regarding comfort settings within the vehicle, it would be desirable to provide systems and methods that can remotely control one or more comfort settings within a cabin of a vehicle, such as an autonomous vehicle, so that the comfort settings are adjusted to passenger's preferences (e.g., when the passenger enters the vehicle). Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for controlling a vehicle. In one embodiment, a method is provided for remotely controlling one or more comfort settings within a cabin of a vehicle. In accordance with the method, a comfort settings profile is configured that specifies the one or more comfort settings. In one embodiment, the one or more comfort settings of the comfort settings profile are specified by a passenger prior to entering the vehicle to allow the one or more comfort settings to be automatically adjusted prior to a scheduled pickup time. A comfort settings management system generates, based on the comfort settings of the comfort settings profile, control signals to control the one or more comfort settings within the vehicle in accordance with the comfort settings profile. A controller of the vehicle generates commands based on the control signals. The commands adjust settings of one or more comfort sub-systems within the vehicle to control the one or more comfort settings within the vehicle such that actual comfort settings within the vehicle are adjusted in advance of the passenger entering the vehicle (e.g., so that the actual comfort settings of the one or more comfort sub-systems match those specified in the comfort settings profile of that passenger before the passenger enters the vehicle). As such, at least a portion of the cabin of the vehicle is pre-conditioned before the passenger enters the vehicle so that actual comfort settings within the vehicle are adjusted when the passenger is scheduled to enter the vehicle.

In another embodiment, a vehicle is provided that includes one or more comfort sub-systems, a communication interface, and a controller. The communication interface receives control signals from a comfort settings management system. The control signals indicate one or more comfort settings of the one or more comfort sub-systems. The controller can generate commands, based on the control signals, that automatically adjust settings of the one or more comfort sub-systems to control the one or more comfort settings within the vehicle.

In another embodiment, a system is provided that remotely controls one or more comfort settings within a cabin of a vehicle. The system includes a user device and a comfort settings management system. The user device is configured to execute an application that receives input information that specifies the one or more comfort settings to be part of a comfort settings profile. The one or more comfort settings of the comfort settings profile are updateable via the application at any time such the one or more comfort settings of the comfort settings profile are dynamically adjustable. The comfort settings management system is configured to store the comfort settings profile and to generate control signals, based on the comfort settings of the comfort settings profile, to control the one or more comfort settings within the vehicle in accordance with the comfort settings profile. For example, in one embodiment, the control signals are used to control the one or more comfort settings within a portion of the cabin of the vehicle that is at least within a vicinity of a seat that is assigned to the passenger.

In one embodiment, the vehicle includes at least one controller configured to generate commands based on the control signals. The commands adjust settings of one or more comfort sub-systems within the vehicle to control the one or more comfort settings within the vehicle such that actual comfort settings within the vehicle are adjusted in advance of a passenger entering the vehicle so that the actual comfort settings of the one or more comfort sub-systems match those specified in the comfort settings profile of the passenger before the passenger enters the vehicle.

In one embodiment, the cabin of the vehicle is divided into compartments for each passenger, and each compartment is isolated from other compartments so that each passenger independently controls the comfort settings within the compartment that the passenger is assigned to.

In one embodiment, the one or more comfort settings of the comfort settings profile are specified by a passenger prior to entering the vehicle to allow the one or more comfort settings to be automatically adjusted prior to a scheduled pickup time when the passenger is scheduled to enter the vehicle. This way, at least a portion of the cabin of the vehicle is pre-conditioned before the passenger enters the vehicle.

In one embodiment, the one or more comfort settings are communicated from the application that executes at the user device to the comfort settings management system in response to a reservation request being communicated from the application that schedules the vehicle to arrive at a requested location by a specified time.

The one or more comfort settings each specify a value of a parameter that affects a comfort level of a passenger when the passenger is scheduled to be within the vehicle. For example, the one or more comfort settings comprise, in one embodiment, a temperature-level setting within at least a portion of the vehicle. At least one controller of the vehicle generates commands based on the control signals to adjust settings of one or more temperature sub-systems that control a temperature within the vehicle to control the temperature-level setting. As such, an actual temperature-level setting will match the temperature-level setting specified in the comfort settings profile of a passenger before the passenger enters the vehicle. The one or more temperature sub-systems within the vehicle include, for example, a heating system of the vehicle, an air-conditioning system of the vehicle, a heating sub-system and/or a cooling sub-system located anywhere within a seat of the vehicle, a hand warmer sub-system located anywhere within the cabin of the vehicle, and/or a sub-system that controls open or closed status of one or more windows or a sunroof of the vehicle.

In another embodiment, the one or more comfort settings also include a lighting-level setting within at least a portion of the vehicle. At least one controller of the vehicle generates commands, based on the control signals, that adjust settings of one or more lighting sub-systems that control lighting within the vehicle to control the lighting-level setting such that an actual lighting-level setting will match the lighting-level setting specified in the comfort settings profile of a passenger before the passenger enters the vehicle. For example, the one or more lighting sub-systems within the vehicle include: a light disposed within the cabin of the vehicle, a display located within the cabin of the vehicle, a sub-system that controls open or closed status of one or more windows or a sunroof of the vehicle, and/or a sub-system that controls tinting of one or more windows of the vehicle.

In another embodiment, the one or more comfort settings also include a sound-level setting within at least a portion of the vehicle. At least one controller of the vehicle generates commands, based on the control signals, that adjust settings of one or more sound sub-systems that control sound within the vehicle to control the sound-level setting such that an actual sound-level setting will match the sound-level setting specified in the comfort settings profile of a passenger before the passenger enters the vehicle. For example, the one or more sound sub-systems within the vehicle include one or more speakers within the cabin of the vehicle; an active noise cancellation system of the vehicle, and/or any sub-systems that control the open or closed status of the windows or a sunroof.

In one embodiment, the system includes a server system that is configured to host the comfort settings management system. The server system is communicatively coupled to the user device via communication infrastructure. The user device indirectly communicates the comfort settings profile to the comfort settings management system via the communication infrastructure. The comfort settings management system communicates the control signals to the vehicle to control one or more comfort settings within the vehicle. In one embodiment, the vehicle is an autonomous vehicle, and the server system is part of an autonomous vehicle based remote transportation system.

In another embodiment, the comfort settings management system is hosted at a computer within the vehicle, and is communicatively coupled to the user device. The user device communicates the comfort settings profile to the comfort settings management system. The vehicle comprises at least one controller configured to generate commands based on the control signals, and the comfort settings management system communicates the commands to one or more comfort sub-systems within the vehicle to control one or more comfort settings within the vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a an automated comfort control system in accordance with various embodiments;

FIG. 2 is a functional block diagram illustrating a transportation system having one or more autonomous vehicles of FIG. 1 in accordance with various embodiments;

FIG. 3 is a functional block diagram illustrating an autonomous driving system (ADS) in accordance with various embodiments;

FIG. 4A is a schematic diagram that illustrates the concept of remotely controlled vehicle comfort settings in accordance with various embodiments;

FIG. 4B is a flowchart that illustrates a method for remotely controlling comfort settings within a vehicle in accordance with various embodiments;

FIG. 5 is a flowchart illustrates a control method for remotely controlling comfort settings for a particular user in accordance with various embodiments;

FIG. 6 is a flowchart that illustrates a method for remotely controlling comfort settings in the vicinity of a particular seat assigned to a particular user based on the user's comfort setting profile in accordance with various embodiments;

FIG. 7 is a diagram that illustrates a system for controlling temperature settings in and around a particular seat is located within a vehicle in accordance with various embodiments;

FIGS. 8A through 8E illustrate one implementation of a hand warmer in accordance with various embodiments; and

FIG. 9 illustrates another implementation of a hand warmer in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

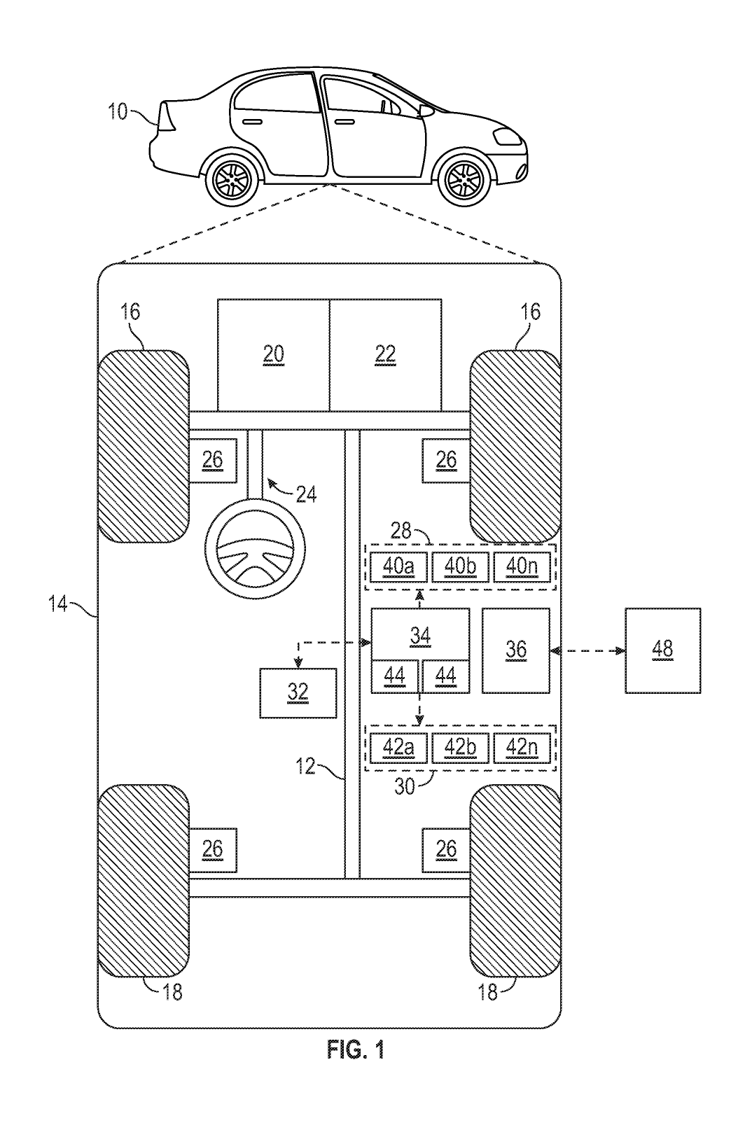

FIG. 1 illustrates an example of a vehicle 10 in which an automated comfort control system can be implemented in accordance with various embodiments. In general, the automated comfort control system can automatically control one or more comfort settings of the vehicle 10 based on a comfort settings profile that is specified by a user (e.g., a requestor or passenger). The one or more comfort settings of the vehicle 10 can be specified by the user remotely at any time such to allow the automated comfort control system to control the comfort settings within the vehicle 10 so that they match those requested by the user. For example, the user can use an application on a device to specify their desired comfort settings, and the automated comfort control system of the vehicle can then the actual comfort settings within the vehicle 10 to match those specified by the user.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In accordance with some embodiments, the vehicle 10 is an autonomous vehicle and the automated comfort control system is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors of the vehicle 10, a trunk of the vehicle 10, and cabin features of the vehicle 10 such as a heating system of the vehicle 10, an air-conditioning system of the vehicle 10, a heating sub-system or a cooling sub-system located anywhere within a seat of the vehicle 10, a hand warmer sub-system located anywhere within the cabin of the vehicle 10, a sub-system that controls open or closed status of windows or a sunroof of the vehicle 10, lighting sub-systems within the vehicle 10 (e.g., a light disposed within the cabin of the vehicle 10), a display located within the cabin of the vehicle 10, a sub-system that controls tinting of windows of the vehicle 10, speakers within the cabin of the vehicle 10, etc. (not numbered).

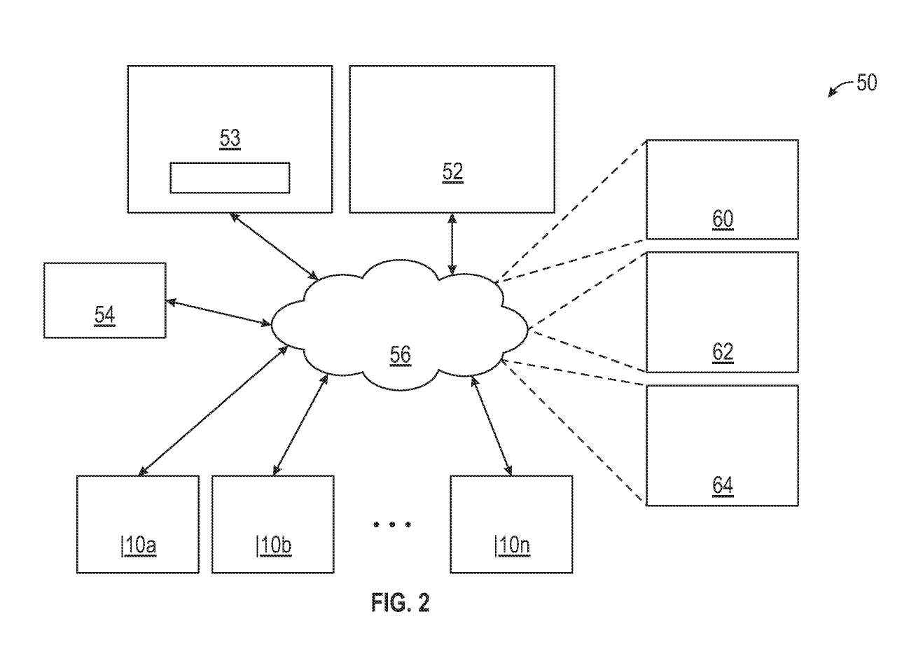

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals and commands to automatically control features of the autonomous vehicle 10.

In various embodiments, the controller 34 can include instructions to provide an at least part of an automated comfort control system that, when executed by the processor 44, can remotely control one or more comfort settings within a cabin of the vehicle 10. For example, in one embodiment, control signals are used to control the comfort settings within the cabin of the vehicle 10 (e.g., within a portion of the cabin that is within a vicinity of a seat that is assigned to a particular passenger). In one embodiment, the cabin of the vehicle 10 is divided into separate compartments for each passenger that are isolated from each other, and each passenger can independently control the comfort settings within the compartment that the passenger is assigned to.

For example, a user device (not illustrated) can execute an application that receives input information that specifies comfort settings to be part of a comfort settings profile. The comfort settings of the comfort settings profile are updateable via the application at any time so that the comfort settings of the comfort settings profile are dynamically adjustable. In one embodiment, the one or more comfort settings of the comfort settings profile are specified by a passenger prior to entering the vehicle to allow the one or more comfort settings to be automatically adjusted prior to a scheduled pickup time when the passenger is scheduled to enter the vehicle. This way, at least a portion of the cabin of the vehicle is pre-conditioned before the passenger enters the vehicle.

A comfort settings management system (not illustrated in FIG. 1) can store the comfort settings profile and generate control signals, based on the comfort settings of the comfort settings profile, to control comfort settings within the vehicle 10 in accordance with the comfort settings profile. In one embodiment, the controller 34 can generate commands, based on the control signals, that adjust settings of one or more comfort sub-systems (not illustrated in FIG. 1) within the vehicle to control the comfort settings within the vehicle 10. As such the actual comfort settings within the vehicle are adjusted in advance of a passenger entering the vehicle (e.g., before the passenger enters the vehicle) so that the actual comfort settings of the comfort sub-systems match those specified in the comfort settings profile of the passenger.

In one embodiment, other entities 48 can include a server system that hosts the comfort settings management system. The server system communicates with a user device via communication infrastructure. For example, the user device can indirectly communicate the comfort settings profile to the comfort settings management system via the communication infrastructure, and the comfort settings management system can in turn communicate control signals to the vehicle 10 that are processed and used to control one or more comfort settings within the vehicle 10. In an embodiment that will be described below, the server system can be part of an autonomous vehicle based remote transportation system. In one embodiment, the application that executes at the user device can communicate the comfort settings to the comfort settings management system in response to a reservation request being communicated from the application that schedules the vehicle to arrive at a requested location by a specified time.

In another embodiment, the comfort settings management system is hosted at the controller 34 of the vehicle 10 (or at any computer within the vehicle 34), and is communicatively coupled to a user device (not illustrated) via the communication system 36. The user device can communicate the comfort settings profile to the comfort settings management system, and the comfort settings management system can communicate information to the vehicle 10 that specifies the user's comfort settings. One or more controller(s) 34 can generate commands, based on the control signals, and communicate the commands to one or more comfort sub-systems (not illustrated) within the vehicle to control one or more comfort settings within the vehicle 10. The comfort settings can each specify a value of a parameter that affects a comfort level of a passenger when the passenger is scheduled to be within the vehicle 10.

For example, the comfort settings can include a temperature-level setting(s) within the vehicle 10. The controller 34 of the vehicle 10 generates commands based on the control signals to adjust settings of temperature sub-systems (not illustrated) that control a temperature within the vehicle 10 to thereby control the temperature-level setting. As such, an actual temperature-level setting will match the temperature-level setting specified in the comfort settings profile of a passenger before the passenger enters the vehicle 10. The temperature sub-systems within the vehicle 10 can include, for example, a heating system of the vehicle 10, an air-conditioning system of the vehicle 10, a heating sub-system or a cooling sub-system located anywhere within a seat of the vehicle 10, a hand warmer sub-system located anywhere within the cabin of the vehicle 10, and/or a sub-system that controls open or closed status of windows or a sunroof of the vehicle 10.

The comfort settings can also include lighting-level setting(s) within the vehicle 10. The controller 34 of the vehicle 10 generates commands, based on the control signals, that adjust settings of lighting sub-systems that control lighting within the vehicle 10 to control the lighting-level setting such that an actual lighting-level setting will match the lighting-level setting specified in the comfort settings profile of a passenger before the passenger enters the vehicle 10. For example, the lighting sub-systems within the vehicle 10 can include, for example, a light disposed within the cabin of the vehicle 10, a display located within the cabin of the vehicle 10, a sub-system that controls open or closed status of windows or a sunroof of the vehicle 10, and/or a sub-system that controls tinting of windows of the vehicle 10.

The comfort settings can also include sound-level setting(s) within the vehicle 10. The controller 34 of the vehicle 10 generates commands, based on the control signals, that adjust settings of sound sub-systems that control the sound level or soundscape within the vehicle 10. For example, a sound-level setting can be controlled such that an actual sound-level setting will match the sound-level setting specified in the comfort settings profile of the passenger before the passenger enters the vehicle 10. For example, the sound sub-systems within the vehicle 10 can include, for example, speakers within the cabin of the vehicle 10; an active noise cancellation system of the vehicle 10, and/or any sub-systems that control the open or closed status of the Windows or a sunroof.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request (also referred to as a reservation request herein) via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

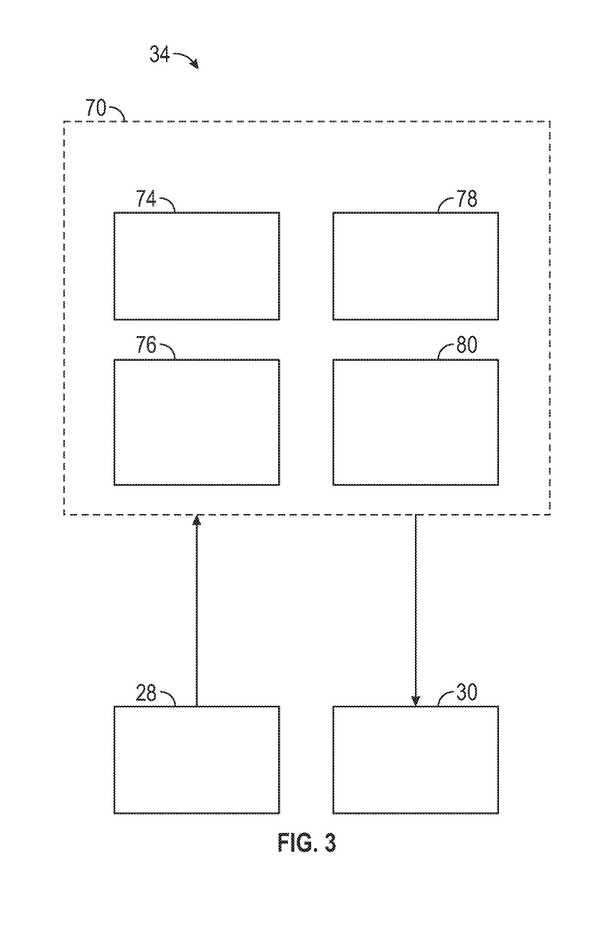

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

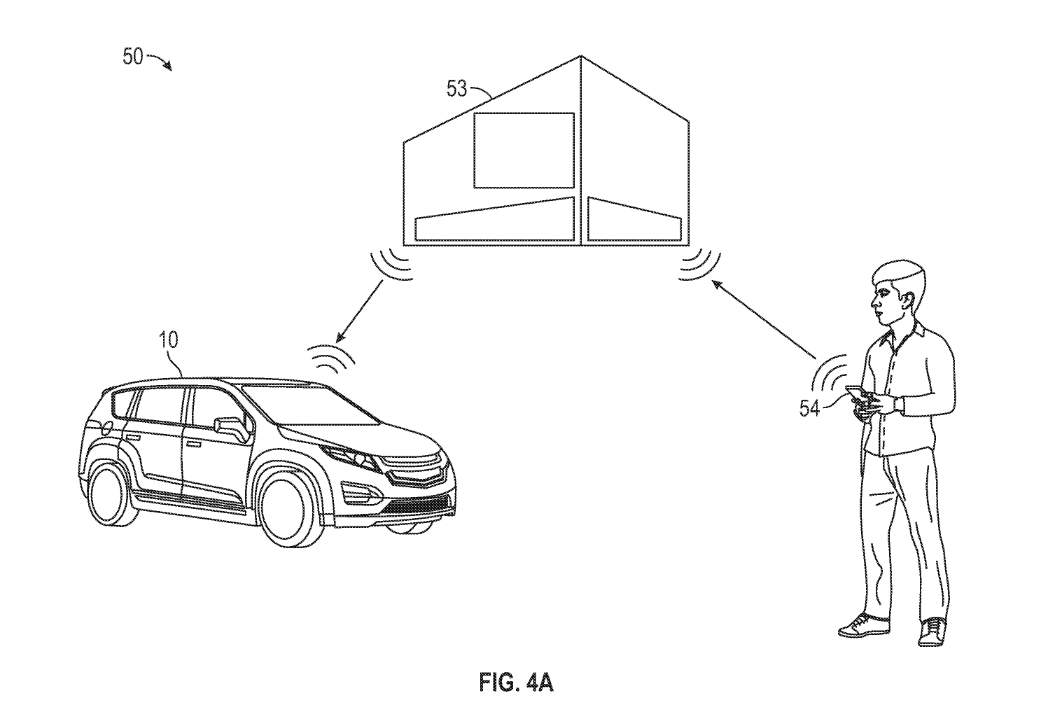

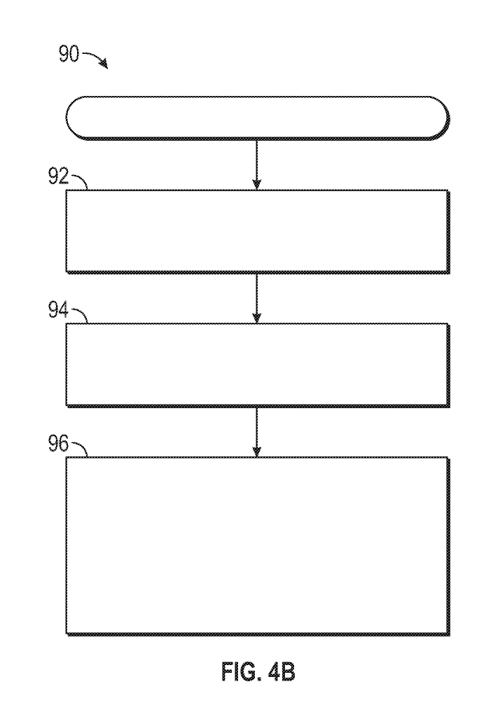

As will be described below with reference to FIGS. 4A-7, in some embodiments, the automated comfort control system of the vehicle 10 can be managed and controlled by a comfort settings management system 53 that can be implemented as a separate backend component, for example, a server or server system, or can be implemented at the autonomous vehicle based remote transportation system 52, or alternatively can be implemented, at least in part, at the autonomous vehicle 10.

As will be described below, the disclosed embodiments can allow each passenger to remotely control the environment within the cabin of the vehicle (e.g., within the vicinity of the seat that they are sitting in) so that it meets the user's desired comfort settings. Each passenger can do this in advance of entering the vehicle such that conditions within the vehicle have been set to match desired comfort settings of that passenger. Although the embodiments described herein will be described as being applied in the context of the autonomous vehicle 10, it should be appreciated that the same methodologies can be applied in the context of any vehicle where it is desirable to control comfort settings remotely. The disclosed embodiments are advantageous in the context of autonomous vehicles because many passengers will share the same vehicle, and all have different preferences regarding what is or is not comfortable to them. In addition, because passengers who use autonomous vehicles usually schedule rides in advance and have their ride reserved, there is usually sufficient lead-time so that comfort settings can be adjusted prior to a scheduled pickup.

FIG. 4A is a schematic diagram that illustrates the concept of remotely controlled vehicle comfort settings in accordance with the disclosed embodiments. FIG. 4A will be described with reference to FIG. 4B, which illustrates a method 200 for remotely controlling comfort settings within a vehicle in accordance of the disclosed embodiments. The method 90 begins at 92, where a user (also referred to as a requestor or a passenger herein) configures a comfort settings profile that specifies one or more comfort settings prior to entering the vehicle. For example, in one embodiment, the user can utilize an application on their user device 54 to remotely control comfort settings within the vehicle 10. The application on their user device 54 can be used to control comfort settings within the vehicle 10. This can happen in various different ways depending on the implementation including, but not limited to, by communicating the comfort settings profile to the vehicle either directly from the user device or indirectly through other infrastructure. For example, in one embodiment, the user's comfort settings profile can be communicated to the vehicle 10 indirectly via other communication infrastructure that relays the users comfort setting profile to the vehicle. The user can also dynamically adjust certain comfort settings via the application at any time to update the comfort settings profile (e.g., create an updated comfort settings profile).

In one embodiment, the application that executes at the user device 54 communicates with the comfort settings management system 53, and the comfort settings management system 53 communicates control signals to the vehicle 10 that control the comfort settings within the vehicle 10 according to the user's preferences. For example, the application can communicate either a comfort settings profile or settings for the comfort settings profile to the comfort settings management system 53. The comfort settings management system 53 can store a comfort settings profile for each user. Depending on the implementation, the comfort settings management system 53 can be implemented at a remote server or within the vehicle itself.

The method 90 continues at 94, where the comfort settings management system 53 generates control signals based on the one or more comfort setting(s) specified in the comfort setting's profile. The control signals indicate the comfort settings of the user's comfort settings profile. The comfort settings management system 53 can then communicate the control signals to the vehicle 10.

The method 90 continues at 96, where one or more controllers of the vehicle can process the control signals to generate commands that automatically adjust settings of one or more comfort sub-systems within the vehicle. The commands automatically adjust settings of the comfort sub-system(s) to control the comfort setting(s) within the vehicle so that actual comfort settings within the vehicle are adjusted in advance of the passenger entering the vehicle 10. For example, the controller(s) of the vehicle 10 can adjust the settings of certain sub-systems (that control the comfort settings) so that the user's desired settings specified by the user's comfort settings profile have been set when the user enters the vehicle (e.g., when the vehicle arrives to pick up the user).

In one implementation, the user device 54 can generate communicate the control signals that convey the comfort settings directly to the controller(s) of the vehicle 10, for example, via a Bluetooth transmitter of the user device 54 that is communicatively coupled to a Bluetooth receiver is located within the vehicle. Alternatively, in another implementation, the user device 54 can communicate comfort settings to the vehicle 10 indirectly through communication infrastructure including any of the communication infrastructure described with reference to FIG. 2 above. For example, the user device 54 may communicate the control signals to the vehicle 10 over a cellular network, WLAN, a satellite network, etc.

In another implementation that's illustrated in FIG. 4A, the user device 54 communicates comfort settings to the comfort settings management system 53. The comfort settings management system 53 can store a comfort settings profile for each user. Each comfort settings profile includes one or more comfort settings specified by that user. Each user can update their comfort settings profile at any time via the application on their user device 54 (e.g., smart phone or other computer). In one implementation, the user can also use an application on their user device 54 to submit a reservation request or schedule being picked up by the vehicle 10. When the user submits a request to be picked up by a vehicle 10, the comfort settings management system 53 will automatically communicate control signals to the vehicle 10 that specify the user's comfort settings profile, and one or more controllers of the vehicle 10 will automatically adjust certain sub-systems within the vehicle so that the users comfort setting preferences, as specified by their comfort settings profile, are set when the vehicle 10 arrives to pick the user up.

Regardless of the implementation, when the vehicle receives the users comfort settings, one or more controllers of the vehicle 10 will automatically adjust systems within the vehicle 10 as needed so that the comfort settings specified by the user's comfort settings profile will be set within the vehicle so that they are set when the user is scheduled to enter the vehicle (e.g., when the vehicle is scheduled to pick the user up).

The comfort settings can specify any number of different parameters that affect the users comfort level when they are scheduled to be in the vehicle. Examples of these comfort settings can include, but are not limited to, a temperature-level setting within at least a portion of the vehicle, a lighting-level setting within at least a portion of the vehicle, a sound-level setting within at least a portion of the vehicle, etc.

Examples of sub-systems or elements used to adjust or control these comfort settings can include, but are not limited to, any sub-systems or elements a control temperature within the vehicle, any sub-systems or elements that control lighting within the vehicle, any sub-systems or elements that control sound level or soundscape within the vehicle, any sub-systems or elements that control the open or closed status of the Windows or a sunroof, the tinting of the windows or sunroof in vehicles that have self-tinting windows, etc. In some embodiments, the cabin of the vehicle can be divided into compartments for each passenger that have a high degree of isolation. In other words, each passenger can sit in their own compartment, and various comfort settings, such as temperature, light, sound, etc. can be independently controlled in each compartment so that each passenger can control comfort settings within the environment defined by the compartment they are sitting in.

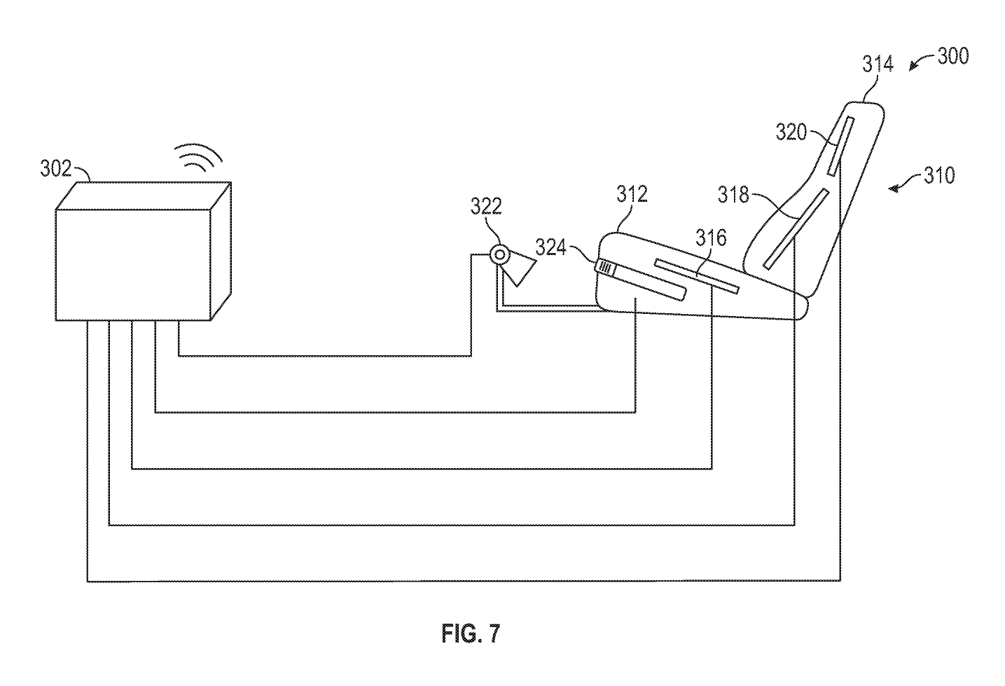

Examples of sub-systems or elements that control temperature within the vehicle can include, but are not limited to, the heating system of the vehicle, the air-conditioning system of the vehicle, heating or cooling sub-systems or elements located anywhere within the seat of the vehicle, hand warmer elements located anywhere within the vehicle including in the seat, on the seat, or attached to the seat, etc. For purposes of illustration, an example will be described below with reference to FIGS. 7-9 for controlling hand warmer elements, but it should be appreciated that this example is not limiting and that the same control systems and methodologies can be applied to remotely control any other sub-systems or elements within the cabin of the vehicle that affect a passenger's comfort level so that the cabin of vehicle is pre-conditioned when the passenger enters the vehicle.

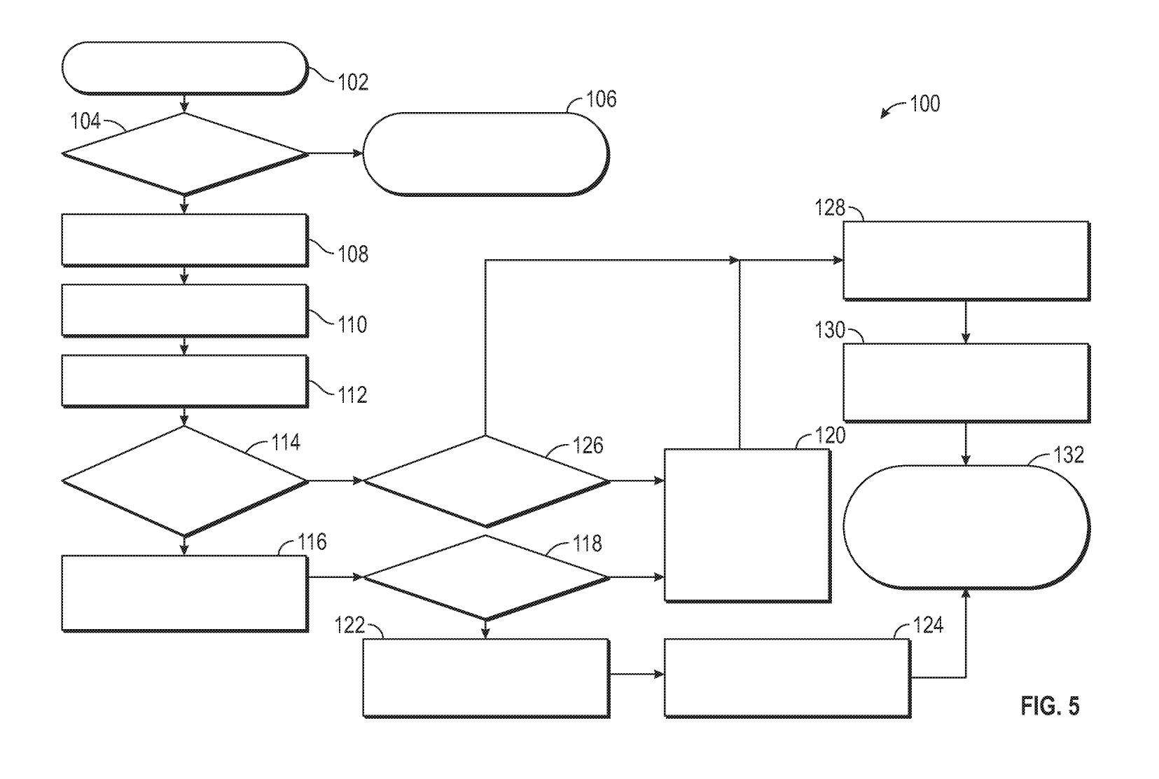

FIG. 5 is a flowchart illustrates a control method 100 for remotely controlling comfort settings for a particular user in accordance with various embodiments. FIG. 5 will be described with continued reference to FIGS. 1-4. As can be appreciated in light of the disclosure, the order of operation within the method is not limited as illustrated in FIG. 5, but may be performed in one or more varying orders as applicable and in accordance with the present disclosure. In addition, it should be understood that steps of the method 100 are not necessarily limiting, and that steps can be added, omitted, and/or performed simultaneously without departing from the scope of the appended claims. It should also be appreciated that the method 100 may include any number of additional or alternative tasks, that the tasks shown in FIG. 5 need not be performed in the illustrated order, and that the method 100 may be incorporated into a more comprehensive procedure or process having additional functionality not described in detail herein. Moreover, one or more of the tasks shown in FIG. 5 could be omitted from an embodiment of the method 100 as long as the intended overall functionality remains intact. It should also be understood that the illustrated method 100 can be stopped at any time. The method 300 is computer-implemented in that various tasks or steps that are performed in connection with the method 300 may be performed by software, hardware, firmware, or any combination thereof. In certain embodiments, some or all steps of this process, and/or substantially equivalent steps, are performed by execution of processor-readable instructions stored or included on a processor-readable medium.

In various embodiments, the method 100 can be triggered based on one or more predetermined events. In one embodiment, the method 100 begins at 102 when the comfort settings management system 53 receives a reservation request from an application that is executing at a user device 54 of the user. At 104, the comfort settings management system 53 confirms whether any vehicles within the fleet are available to pick the user up at the scheduled time and location specified by the user in the reservation request. If no vehicles are available at 104, the method 100 proceeds to 106, where the comfort settings management system 53 generates a response indicating that no vehicles are available and communicates the response message back to the user device 54. The application displays the response message to the user so that the user is aware that the reservation request has been denied because no vehicles are available.

By contrast, when the comfort settings management system 53 determines that a vehicle is available to pick the user up at the scheduled time and location (as specified in the user's reservation request), the method 100 proceeds to 108, where the system generates a response message that includes a map showing one or more available vehicles that can satisfy the users reservation request. When the response message is received at the user device 54, the application displays the map and allows the user to select one of the vehicles for their reservation request.

When the user makes a selection, the application on the user device 54 will automatically generate and communicate the user's selection back to the comfort settings management system 53. When the comfort settings management system 53 receives the user's selection at 110, the method 100 proceeds to 112, where the comfort settings management system 53 can communicate a message to the user device 54 that indicates that the user's selection is confirmed. The application displays this message so that the user is aware that the vehicle the user selected is available to pick the user up at the requested time and location, and the method 100 proceeds to 114.

At 114, the comfort settings management system 53 determines whether it has a comfort settings profile stored for the user who is logged into and using the application at the user device 54.

When the comfort settings management system 53 determines (at 114) that it does not have a comfort settings profile stored for the user, the method 100 can proceed to 116, where the comfort settings management system 53 can generate and send a message to the user device 54, which causes the application to present a prompt to the user giving the user the option to create a comfort settings profile that can be used to remotely specify certain comfort settings within the vehicle 10. The user can then use an application executing at the user device 54 to either accept or decline the opportunity to create a comfort settings profile.

When the user accepts the opportunity to create their comfort settings profile at 118, the method 100 proceeds to 120. At 120, the application at the user device 54 presents the user with a number of different comfort setting options that can be set by the user to complete their comfort settings profile. Once the user has completed their comfort settings profile, and hits save/submit, the application generates a message and communicates it back to the comfort settings management system 53. This message includes all the various comfort settings needed to create a comfort settings profile for that particular user. At 128, the comfort settings management system 53 can then communicate information (e.g., signals) that indicates the comfort settings of the user's comfort settings profile to the vehicle 10, and the method 100 proceeds to 130.

At 130, a controller (e.g., one or more control units) in the vehicle can process the information (e.g., signals) and automatically generate commands to control certain sub-systems or elements within the vehicle. The commands can control settings of the sub-systems or elements to adjust them so that they are set in accordance with the comfort settings specified by that particular user's comfort settings profile at a particular time (e.g., when the vehicle 10 arrives to pick the user up). The method 100 then proceeds to 132.

By contrast, when the user declines the opportunity to create their comfort settings profile at 118, the method 100 proceeds to 122. At 122, the application at the user device 54 generates a message and communicates it back to the comfort settings management system 53. This message indicates that the user does not want to create a comfort settings profile, and the comfort settings management system 53 can then communicate a default comfort settings profile to the vehicle 10 for this particular user. The default comfort settings profile includes instructions indicating that the comfort settings within the vehicle for that particular user should be set to default settings at a particular time (e.g., when the user is scheduled to be picked up at their pickup location). At 124, a controller (e.g., one or more control units) in the vehicle 10 will automatically generate commands to control certain sub-systems or elements within the vehicle to adjust them so that they are set in accordance with the default comfort settings profile at the particular time (e.g., when the vehicle 10 is scheduled to arrive and pick up the user). The method 100 then proceeds to 132.

When the comfort settings management system 53 determines (at 114) that it has a comfort settings profile stored for the user, the method 100 can proceed to 126, where the comfort settings management system 53 can generate and send a message to the user device 54, which causes the application to present a prompt to the user (at 126) giving the user the option to edit the current comfort settings profile.

When the user declines the opportunity to edit the current comfort settings profile (yes at 126), the application at the user device 54 generates a message and communicates it back to the comfort settings management system 53. This message indicates that the user does not want to edit the current comfort settings profile, and the method 100 proceeds to 128 as described above.

When the user chooses to edit the current comfort settings profile (yes at 126), the method 100 proceeds to 120, where the application at the user device 54 presents the user with a number of different comfort setting options that can be set by the user to edit/update their comfort settings profile. Once the user has finished editing the comfort settings of their comfort settings profile, and hits save/submit, the application generates a message and communicates it back to the comfort settings management system 53. This message includes all the various comfort settings (as edited by the user) that are needed to create a comfort settings profile for that particular user. The method 100 then proceeds to 128 as described above.

At 132, when the vehicle 10 arrives to pick up the user, the settings of certain sub-systems or elements within the vehicle have been adjusted so that they are set in accordance with the comfort settings specified by that particular user's comfort settings profile.

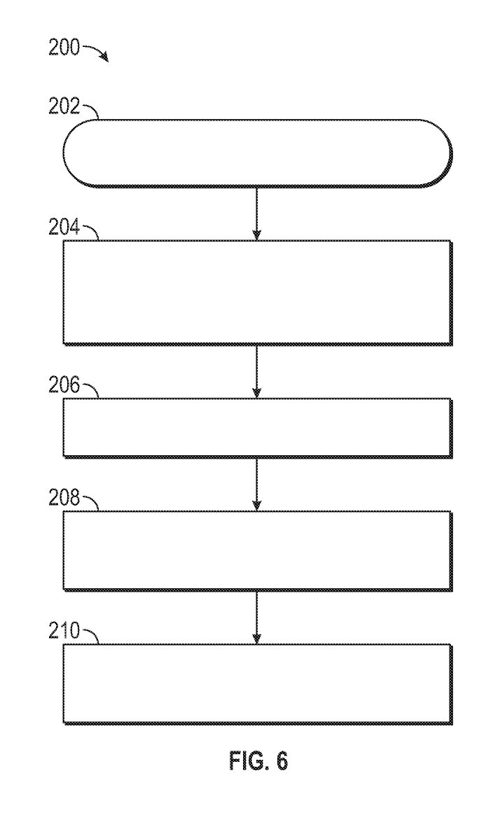

FIG. 6 illustrates a method 200 for remotely controlling comfort settings in the vicinity of a particular seat assigned to a particular user based on the user's comfort setting profile in accordance of the disclosed embodiments. As a preliminary matter, it should be understood that steps of the method 200 are not necessarily limiting, and that steps can be added, omitted, and/or performed simultaneously without departing from the scope of the appended claims. It should be appreciated that the method 200 may include any number of additional or alternative tasks, that the tasks shown in FIG. 6 need not be performed in the illustrated order, and that the method 200 may be incorporated into a more comprehensive procedure or process having additional functionality not described in detail herein. Moreover, one or more of the tasks shown in FIG. 6 could be omitted from an embodiment of the method 200 as long as the intended overall functionality remains intact. It should also be understood that the illustrated method 200 can be stopped at any time. The method 200 is computer-implemented in that various tasks or steps that are performed in connection with the method 200 may be performed by software, hardware, firmware, or any combination thereof. For illustrative purposes, the following description of the method 200 may refer to elements mentioned above in connection with FIGS. 1-4B. In certain embodiments, some or all steps of this process, and/or substantially equivalent steps, are performed by execution of processor-readable instructions stored or included on a processor-readable medium.

The method 200 begins at 202 when the comfort settings management system 53 receives the user's comfort settings profile and seating preferences from an application that is executing at a user device 54 of the user.

At 204, the comfort settings management system 53 can determine based on the user's seating preferences which seat is available (unoccupied) to be assigned to the user. In one embodiment, the comfort settings management system 53 can determine whether the users preferred seat is available or occupied, and if it is not can determine whether the users second choice seat is available or occupied, and if not can determine whether or not the user's third choice seat is available or occupied, and so on. Because the comfort settings management system 53 has already confirmed that the vehicle is available, this means at least one seat in the vehicle is unoccupied.

After the comfort settings management system 53 determines which seat has been assigned to the user, at 206, the comfort settings management system 53 will generate and send a message to the user device 54 that indicates which seat has been assigned to the user. The application running at the user device 54 can display the seat assignment to the user.

At 208, a controller (e.g., one or more control units) in the vehicle 10 will automatically generate commands to control certain sub-systems or elements within or near the seat to adjust them so that the comfort settings specified by that particular user's comfort settings profile (at or in proximity to the seat) are set in accordance with that particular user's comfort settings profile by a particular time (e.g., prior to or when the vehicle 10 arrives to pick the user up). The controller(s) can activate (or deactivate), actuate or disable certain sub-systems or elements to ensure (to the extent possible) that the comfort settings specified by that particular user's comfort settings profile are set per the user's preferences. At 210, when the vehicle arrives to pick up the user, the actual comfort settings within the vehicle are set to match the comfort settings specified by that particular user's comfort settings profile (e.g., are set per the user's preferences).

FIG. 7 is a diagram that illustrates a system for controlling temperature settings in and around a particular seat 310 that is located within a vehicle 10 in accordance with various embodiments. FIG. 7 illustrates one exemplary implementation where a receiver and controller module 302 of the vehicle receives a user's comfort settings profile and controls certain heating and cooling sub-systems or elements based on the user's comfort settings profile to control temperature settings in and around a particular seat 310 that is located within the vehicle.

In the example illustrated in FIG. 7, it is assumed that the user has used an application on their user device 54 to communicate their comfort settings profile to the receiver and controller module 302 of the vehicle 10 (either directly or indirectly). In this particular example, based on the comfort settings indicated in the user's comfort settings profile, the receiver and controller module 302 is configured to generate and communicate various commands that control the temperature, or relative temperature, of various sub-systems or elements located within and in proximity to a particular seat 310 of the vehicle to achieve at least some of the comfort settings indicated in the user's comfort settings profile.

These heating and cooling sub-systems or elements can include a heating element 316 that is located in the base 312 of the seat 310, other heating elements 318, 320 that are located in the seat back 314 of the seat 310, a foot heating and cooling element 322 that can be located in the bottom portion of the passenger cabin near where the passenger's feet would rest when seated in the seat 310, and a hand warmer 324 that can be either attached to or part of the seat 310. Although not illustrated, the cabin of the vehicle could include any number of other heating and cooling elements located throughout the cabin of the vehicle as is known in the art.

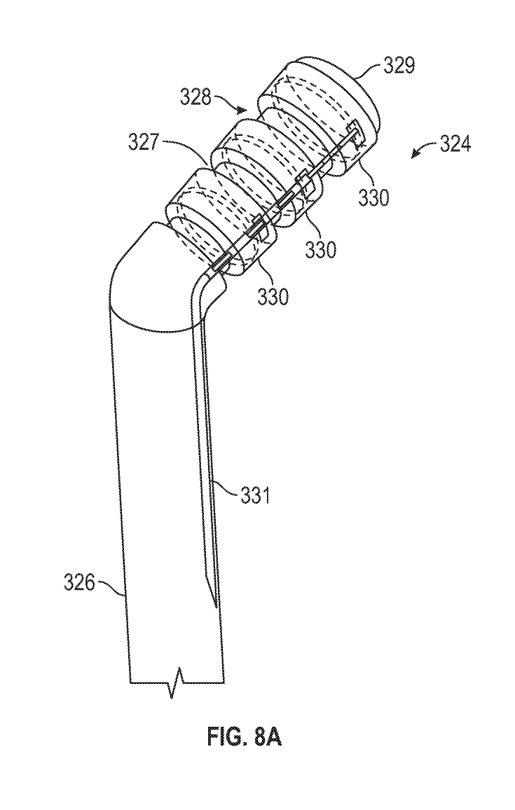

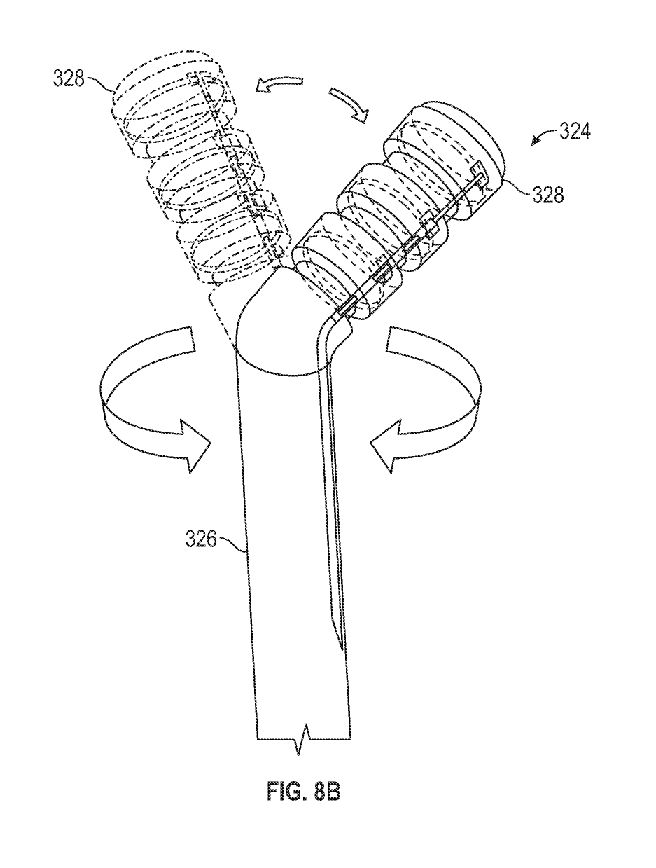

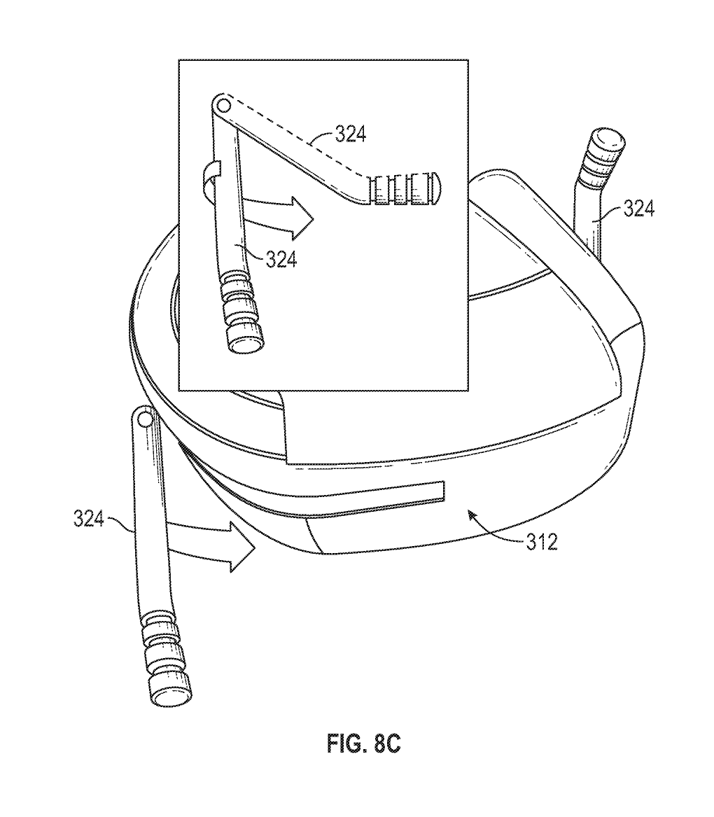

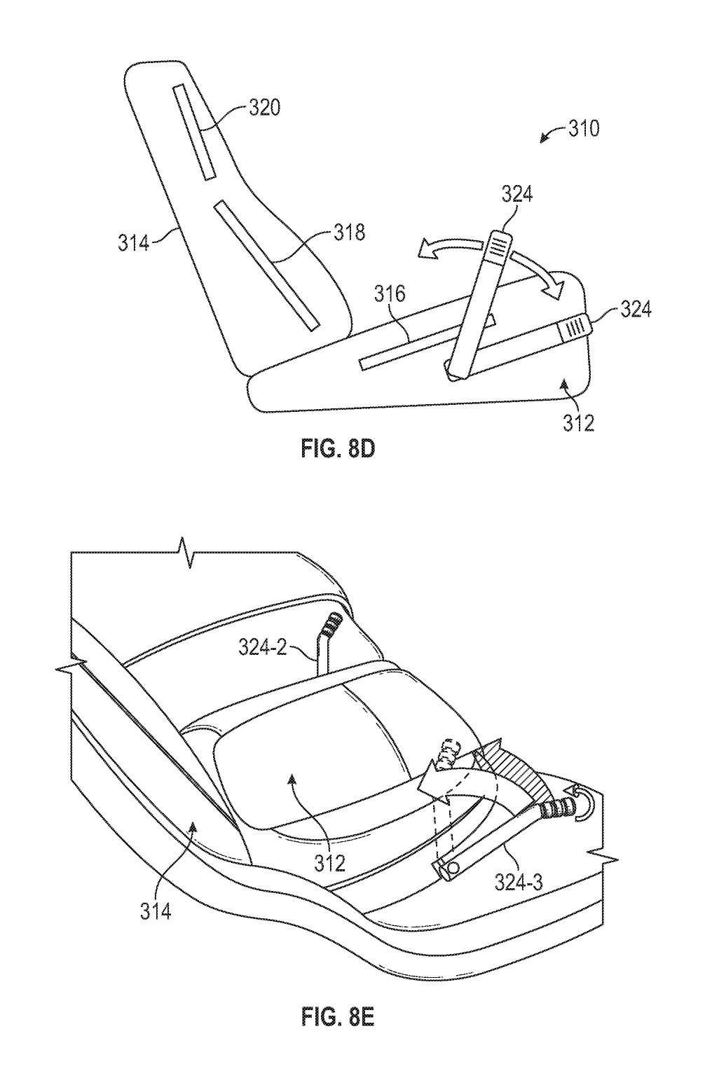

FIGS. 8A through 8E illustrate a non-limiting implementation of a hand warmer 324 in accordance with the disclosed embodiments. As illustrated in FIGS. 8C and 8E, a particular seat 310 within a vehicle will normally include two hand warmers 324, but for sake of simplicity of description, only one will be described with reference to FIGS. 8A through 8E.

In this particular implementation, as shown in FIG. 8A, the hand warmer 324 can include an arm member 326 and an articulating grip handle 328. The arm member 326 can be any arm-like member and may have a debris-phobic surface coating. In one embodiment, the arm member 326 is mechanically attached to the articulating grip handle 328 by a swivel joint (not shown) so that the articulating grip handle 328 can rotate about an axis defined by the arm member as shown by the arrows in FIG. 8B.

In one non-limiting embodiment, the main body 329 of the articulating grip handle 328 can be made a hard-plastic material that is formed into a rod-like shape. A number of flexible heating elements 330 can be cast into the material that makes up the main body 329 of the articulating grip handle 328, and the main body 329 of the articulating grip handle 328 can be encased in a soft, conformal handle material 327 that may also have a debris-phobic surface coating. In operation, line 331 supplies the flexible heating elements 330 with a controlled electric current to control the temperature of the flexible heating elements 330 so that they meet the user's desired comfort settings as specified by their comfort settings profile.

As shown by the arrows in FIG. 8C, the hand warmer 324 can be stowed in a storage portion 325 that can be located in the base 312 of the seat. Although the hand warmer 324 can be stowed within a storage portion 325 that is located in the bottom or base 312 of the seat in the implementation that is illustrated in FIG. 8C, it should be appreciated that this implementation is not limiting, and that the hand warmer 324 could be stored in other portions of the seat. As shown in FIGS. 8C-E, the arm member 326 can be attached to the base 312 of the seat 310 using any conventional attachment mechanism that allows the arm member 326 to rotate about an axis defined by that attachment mechanism. As indicated by the arrows that are illustrated in FIGS. 8A-8C, when the user is ready to use the hand warmer 324, the user can extract the hand warmer 325 from the storage portion 325, and rotate the arm member 326 into any position that the user desires (e.g., into any position that is comfortable for the particular user). As shown in FIGS. 8A and 8C, when the user is done with using the hand warmer 324, the user can once again rotate the arm member 326 and stow the hand warmer 325 back into the storage portion 325.

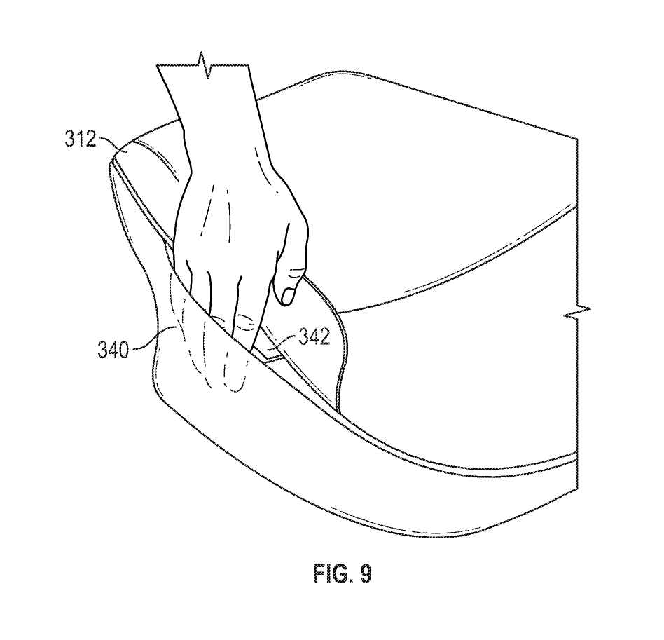

FIG. 9 illustrates another possible implementation of a hand warmer in accordance with the disclosed embodiments. In this implementation, the hand warmer includes a pocket 340 formed in a side portion of the base 312 of the seat 310, and a heating element 342 that is disposed within the base 312 of the seat 310. The user can insert their hand into the pocket 340 where it is warmed by the heat radiated from the heating element 342. In operation, the heating elements 342 is supplied with a controlled electric current to control the temperature of the heating element 342 so that the temperature inside the pocket meets the user's desired comfort settings as specified by their comfort settings profile.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system that is configured to remotely control one or more comfort settings within a cabin of a vehicle, comprising:
a user device that is configured to execute an application that receives input information that specifies the one or more comfort settings to be part of a comfort settings profile; and
a comfort settings management system configured to store the comfort settings profile and to generate control signals, based on the comfort settings of the comfort settings profile, to control the one or more comfort settings within the vehicle in accordance with the comfort settings profile.

2. The system according to claim 1, wherein the vehicle comprises:
at least one controller configured to generate commands based on the control signals, wherein the commands adjust settings of one or more comfort sub-systems within the vehicle to control the one or more comfort settings within the vehicle such that actual comfort settings within the vehicle are adjusted in advance of a passenger entering the vehicle so that the actual comfort settings of the one or more comfort sub-systems match those specified in the comfort settings profile of the passenger before the passenger enters the vehicle.

3. The system according to claim 1, wherein the one or more comfort settings of the comfort settings profile are specified by a passenger prior to entering the vehicle to allow the one or more comfort settings to be automatically adjusted prior to a scheduled pickup time when the passenger is scheduled to enter the vehicle to pre-condition at least a portion of the cabin of the vehicle before the passenger enters the vehicle.

4. The system according to claim 3, wherein the one or more comfort settings are communicated from the application that executes at the user device to the comfort settings management system in response to a reservation request being communicated from the application that schedules the vehicle to arrive at a requested location by a specified time.

5. The system according to claim 1, wherein the one or more comfort settings each specify a value of a parameter that affects a comfort level of a passenger when the passenger is scheduled to be within the vehicle.

6. The system according to claim 1, wherein the one or more comfort settings comprise: a temperature-level setting within at least a portion of the vehicle, and wherein the vehicle comprises:
at least one controller configured to generate commands based on the control signals, wherein the commands adjust settings of one or more temperature sub-systems that control a temperature within the vehicle to control the temperature-level setting such that an actual temperature-level setting will match the temperature-level setting specified in the comfort settings profile of a passenger before the passenger enters the vehicle.

7. The system according to claim 1, wherein the one or more temperature sub-systems within the vehicle include at least one of:
a heating system of the vehicle;
an air-conditioning system of the vehicle;
a heating sub-system or a cooling sub-system located anywhere within a seat of the vehicle;
a hand warmer sub-system located anywhere within the cabin of the vehicle; and
a sub-system that controls open or closed status of one or more windows or a sunroof of the vehicle.

8. The system according to claim 1, wherein the one or more comfort settings comprise: a lighting-level setting within at least a portion of the vehicle, and wherein the vehicle comprises:
at least one controller configured to generate commands based on the control signals, wherein the commands adjust settings of one or more lighting sub-systems that control lighting within the vehicle to control the lighting-level setting such that an actual lighting-level setting will match the lighting-level setting specified in the comfort settings profile of a passenger before the passenger enters the vehicle.

9. The system according to claim 8, wherein the one or more lighting sub-systems within the vehicle include at least one of:
a light disposed within the cabin of the vehicle;
a display located within the cabin of the vehicle;
a sub-system that controls open or closed status of one or more windows or a sunroof of the vehicle; and
a sub-system that controls tinting of one or more windows of the vehicle.

10. The system according to claim 1, wherein the one or more comfort settings comprise: a sound-level setting within at least a portion of the vehicle, and wherein the vehicle comprises:
at least one controller configured to generate commands based on the control signals, wherein the commands adjust settings of one or more sound sub-systems that control sound within the vehicle to control the sound-level setting such that an actual sound-level setting will match the sound-level setting specified in the comfort settings profile of a passenger before the passenger enters the vehicle.

11. The system according to claim 10, wherein the one or more sound sub-systems within the vehicle include at least one of:
one or more speakers within the cabin of the vehicle; and
an active noise cancellation system of the vehicle; and
any sub-systems that control the open or closed status of the Windows or a sunroof.

12. The system according to claim 1, further comprising:
a server system that is configured to host the comfort settings management system, and that is communicatively coupled to the user device via communication infrastructure, wherein the user device indirectly communicates the comfort settings profile to the comfort settings management system via the communication infrastructure, and wherein the comfort settings management system is configured to communicate the control signals to the vehicle to control one or more comfort settings within the vehicle.

13. The system according to claim 12, wherein the vehicle is an autonomous vehicle, and wherein the server system is part of an autonomous vehicle based remote transportation system.

14. The system according to claim 1, wherein the comfort settings management system is hosted at a computer within the vehicle, and is communicatively coupled to the user device, wherein the user device communicates the comfort settings profile to the comfort settings management system, and wherein the vehicle comprises:
at least one controller configured to generate commands based on the control signals, wherein the comfort settings management system communicates the commands to one or more comfort sub-systems within the vehicle to control one or more comfort settings within the vehicle.

15. The system according to claim 1, wherein the one or more comfort settings of the comfort settings profile are updateable via the application of the user device at any time such the one or more comfort settings of the comfort settings profile are dynamically adjustable.

16. The system according to claim 1, wherein the control signals are used to control the one or more comfort settings within a portion of the cabin of the vehicle at least within a vicinity of a seat that is assigned to the passenger.

17. The system according to claim 1, wherein the cabin of the vehicle is divided into compartments for each passenger, wherein each compartment is isolated from other compartments, and wherein each passenger independently controls the comfort settings within the compartment that the passenger is assigned to.

18. A method for remotely controlling one or more comfort settings within a cabin of a vehicle, the method comprising:
configuring a comfort settings profile that specifies the one or more comfort settings; and
generating, at a comfort settings management system based on the comfort settings of the comfort settings profile, control signals to control the one or more comfort settings within the vehicle in accordance with the comfort settings profile.

19. The method according to claim 1, wherein the one or more comfort settings of the comfort settings profile are specified by a passenger prior to entering the vehicle to allow the one or more comfort settings to be automatically adjusted prior to a scheduled pickup time when the passenger is scheduled to enter the vehicle to pre-condition at least a portion of the cabin of the vehicle before the passenger enters the vehicle, the method further comprising:
generating, at a controller of the vehicle, commands based on the control signals, wherein the commands adjust settings of one or more comfort sub-systems within the vehicle to control the one or more comfort settings within the vehicle such that actual comfort settings within the vehicle are adjusted in advance of a passenger entering the vehicle so that the actual comfort settings of the one or more comfort sub-systems match those specified in the comfort settings profile of the passenger before the passenger enters the vehicle.

20. A vehicle, comprising:
one or more comfort sub-systems;
a communication interface configured to receive control signals from a comfort settings management system, wherein the control signals indicate one or more comfort settings of the one or more comfort sub-systems; and
a controller configured to generate commands, based on the control signals, that automatically adjust settings of the one or more comfort sub-systems to control the one or more comfort settings within the vehicle.
